(19) United States
(12) Patent Application Publication
(10) Pub. No.: US 2003/0054867 A1
(43) Pub. Date: Mar. 20, 2003

(54) Method and apparatus for alerting users of incoming calls and messages

(76) Inventors: Homayoun Dowlat, San Diego, CA (US); Guangming Shi, San Diego, CA (US)

Correspondence Address: Sarah Kirkpatrick, Intellectual Property Administration, QUALCOMM Incorporated, 5775 Morehouse Drive, San Diego, CA, 92121-1714, US

(21) Appl. No.: 10/236,210

(22) Filed: Sep. 6, 2002

Related U.S. Application Data
(60) Provisional application No. 60/323,177, filed on Sep. 18, 2001.

(51) Int. Cl. H04B 1/38

(52) U.S. Cl. 455/567; 455/415

(57) ABSTRACT

A mobile communication device, and a method of alerting a user to an incoming call on a communication receiver in communicative contact with at least one communication station, are disclosed. The communication device includes a communication receiver that is in communicative contact with at least one communication station, an audio memory that stores therein a plurality of audio alert types, wherein each alert type is identified with a category, a call categorizer communicatively connected to the communication receiver that assigns an incoming call category to an incoming call received on the communication receiver, a call comparator that compares the incoming call category to the category and outputs, according to the audio memory, the alert type associated with the incoming call category, and an alert player that plays the alert type associated with the incoming call category. The method includes providing an audio memory at the communication receiver, storing in the audio memory a plurality of audio alerts, identifying each audio alert with a category, receiving an incoming call at the communication receiver, assigning an incoming call category to the incoming call, comparing the incoming call category to the category, outputting from said comparing the alert associated with the incoming call category, and playing the alert associated with the incoming call category.

### RELATED APPLICATIONS

This application claims priority to pending Provisional application No. 60/323,177, filed on Sep. 18, 2001, incorporated herein by reference.

### BACKGROUND OF THE INVENTION

1. Field of the Invention

The present invention is directed generally to a method and apparatus for receiving calls and messages and alerting a user on incoming calls and messages on a mobile communication device.

2. Description of the Background

During the normal operation of a pager, or of a mobile telephone, or of similar mobile communication devices, it is common that, upon receipt of an incoming call or message, an alert sound is played to the user by the device. This alert may take the form of a tone, a pulse, a vibrator, or a buzzer, or, in alternative embodiments, may include the display of an icon on the communication device. This tone, pulse, or icon is identical, or similar, for all incoming messages received.

It is known in the art, upon receipt of an incoming call or message, to alert the user of the mobile device. For example, the mobile device may display a small envelope icon upon receipt of a voicemail or SMS message, and may be set to ring if it receives and incoming call.

However, the aforementioned methods do not give the receiver of the message any information as to the content of the message. For example, based on an envelop icon display or the ring tone, the receiver may not know who sent the message or the call, and how urgent the message or call may be. Therefore, the need exists for a mobile communication device that allows the receiver of a message or a call to receive an alert to allow the receiver to differentiate the content of the message, without having to actually read the content of the message or look at the display of the mobile device.

### BRIEF SUMMARY OF THE INVENTION

The present invention is directed to a mobile communication device. The communication device includes a communication receiver that is in communicative contact with at least one communication station, an audio memory that stores therein a plurality of audio alert types, wherein each alert type is identified with a category, a call categorizer communicatively connected to the communication receiver that assigns an incoming call category to an incoming call received on the communication receiver, a call comparator that compares the incoming call category to the category and outputs, according to the audio memory, the alert type associated with the incoming call category, and an alert player that plays the alert type associated with the incoming call category.

The present invention also includes a method of alerting a user to an incoming call on a communication receiver in communicative contact with at least one communication station. The method includes providing an audio memory at the communication receiver, storing in the audio memory a plurality of audio alerts, identifying each audio alert with a category, receiving an incoming call at the communication receiver, assigning an incoming call category to the incoming call, comparing the incoming call category to the category, outputting from said comparing the alert associated with the incoming call category, and playing the alert associated with the incoming call category.

The present invention solves problems experienced with the prior art because it allows the receiver of a message to receive an alert allowing the receiver to actually read the content of the message or look at the display of the incoming call. Those and other advantages and benefits of the present invention will become apparent from the detailed description of the invention hereinbelow.

### BRIEF DESCRIPTION OF THE SEVERAL VIEWS OF THE DRAWINGS

For the present invention to be clearly understood and readily practiced, the present invention will be described in conjunction with the following figures, wherein:

FIG. 1 is a block diagram illustrating a mobile communication device having message alert; and

FIG. 2 is a flow diagram illustrating a method of alerting a user to a mobile communication.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical mobile communication device or system. Those of ordinary skill in the art will recognize that other elements are desirable and/or required in order to implement the present invention. However, because such elements are well known in the art, and because they do not facilitate a better understanding of the present invention, a discussion of such elements is not provided herein.

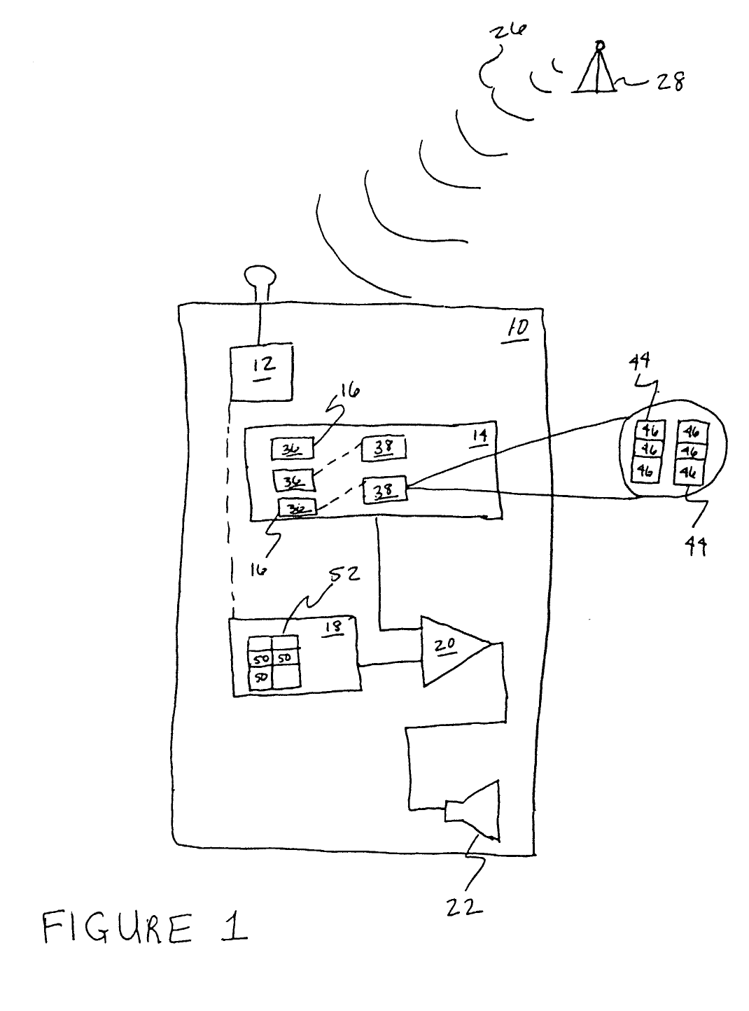

FIG. 1 is a block diagram illustrating a mobile communication device having message alert 10. The mobile communication device 10 includes a communication receiver 12, an audio memory 14 that stores a plurality of audio alerts 16, a call categorizer 18, a call comparator 20, and an audio alert player 22.

The communication receiver 12 is a mobile broadcast receiver, as is known in the art. The communication receiver 12 may be, for example, a cellular telephone, a pager, or a personal digital assistant, for example. The communication receiver 12 receives broadcast messages 26 from a broadcast service center 28. The broadcast service 28 center may be, for example, a mobile telephone antenna station. The broadcast messages 26 may be directed to a single mobile communication device, or to multiple mobile communication devices. For example, in the instance wherein multiple telephones are included on one calling plan, the broadcast messages 26 may be directed to all telephones on the single calling plan. In one embodiment of the present invention, the messages 26 broadcast may be short message service (SMS) messages. The broadcast messages 26 may also include, for example, incoming calls in progress, pages and/or caller ID information. In an illustrative embodiment, the communication receiver 10 is capable of receiving any point to point messages, or point to multi-point messages, capable of being sent from a broadcast service center 28.

The audio memory 14 is a memory device as is known in the art, such as a RAM, that is included in the mobile communication device 10. The audio memory 14 stores therein a plurality of audio alert types 16, wherein each audio alert type 16 is identifiable by a different sound associated with the audio alert type 16, wherein the different sound is to be played by the audio alert player 22. The audio alert types 16 may include, for example, a standard mobile communication device pulse or tone, such as a short tone or a long tone, an MIDI type of sound, or any recorded sound, such as a voice, horn, or other type of alerting sound. Each audio alert type 16 stored in the audio memory 14 is identified in its storage location 36 in the audio memory 14 with a category 38 corresponded to that audio alert type 16. The category 38 or categories 38 may be set into the audio memory 14 by the user of the communication device 10, the owner of the communication device 10, the manufacturer of the communication device 10, a programmer of the communication device 10, the sender of the broadcast message 26 to the communication device 10, or the broadcast service center 28, for example. The category 38 or categories 38 may be entered by the sending of a signal containing programming information to the audio memory 14, by the manual entry of programming information via, for example, a keypad of the mobile communication device 10, or by hardware programming during manufacture of the mobile communication device 10.

The category 38 or categories 38 may be set according to several different criteria 44, which criteria 44 may then include categories 46, each category of which is assigned a different category 38. For example, the category 38 may be based on the criteria 44 of message type, such as the categories 46 of a broadcast of stock quotes, a broadcast of sports news, a broadcast of weather, or a broadcast of personal information, such as email. Alternatively, the category 38 can be assigned based on the criteria 44 of caller identification/caller name from which the incoming message is received. For example, a first category may be assigned to a category 46 of family member, a second category may be assigned to a business associate, and a third category may be assigned to friend or social acquaintance. Alternatively, the category 38 may be assigned based on the criteria 44 of urgency of the incoming message 26. For example, messages 26 may be categorized according to emergency message, urgent message, important message, casual message, or undesired message. A category 46 into which the message 26 is placed may be decided based on information in the incoming message 26, or based on information of where the incoming message 26 is incoming from, by the call categorizer, as discussed hereinbelow.

The call categorizer 18 is communicatively connected to the communication receiver 12, and assigns an incoming call category 50 to an incoming call 26 or message 26 received at the communication receiver 12. The incoming call category 50 is assigned according to the same categories 46 within the same criteria 44 as are assigned to the category 38 or categories 38 in the audio memory 14. The call categorizer 18 may decide the incoming call category 50 based on information in the incoming message 26, or based on information of where the incoming message 26 was sent from, or based on information of from whom the incoming message 26 was sent, for example. In a illustrative embodiment, the call categorizer 18 is software or hardware that compares information in the incoming message 26, or information of where the incoming message 26 is from, for example, to a known set of incoming call categories 50, divided into the same criteria 44 and categories 46 as the category 38 or categories 38 in the audio memory 14, which incoming call categories 50 are resident, for example, in a call categorizer memory 52.

The call comparator 20 compares the incoming call category 50, as assigned by the call categorizer 18, to the categories 38 in the audio memory 14, and outputs the audio alert type 16 associated with the incoming call category 50. The call comparator 20 may be, for example, a hardware comparator capable of comparing the necessary information, or may be a software routine capable of carrying out the required comparison. The call comparator 20 outputs the audio alert type 16 to the audio player 22. The audio alert player 22 plays the audio alert associated with the audio alert type 16 of the incoming call category 50. The audio alert player 22 is preferably, for example, a buzzer, speaker, or horn, capable of playing the audio alert assigned to the incoming call category 50. The audio alert player 22 plays a sound corresponded to the assigned audio alert type 16. The sound played by the audio alert player 22 may be a particular sound, or may, in certain embodiments, be no sound, if, for example, the audio alert type 16 associated with, for example, a call assigned an incoming call category 50 of an undesired call, is received. Additionally, the audio alert player 22 may be programmable to operate in different modes, such as, for example, operating in silent mode. While operating in silent mode, the alert player 22 plays no sound when the user is then currently in another call, for example. Or, in an additional illustrative embodiment, the audio alert player 22 may be programmed to play only certain sounds associated with certain incoming call categories 50 at certain times, such as, for example, playing a no sound for all important, casual, or undesired calls, but playing a sound associated with an emergency or urgent call type while in another call.

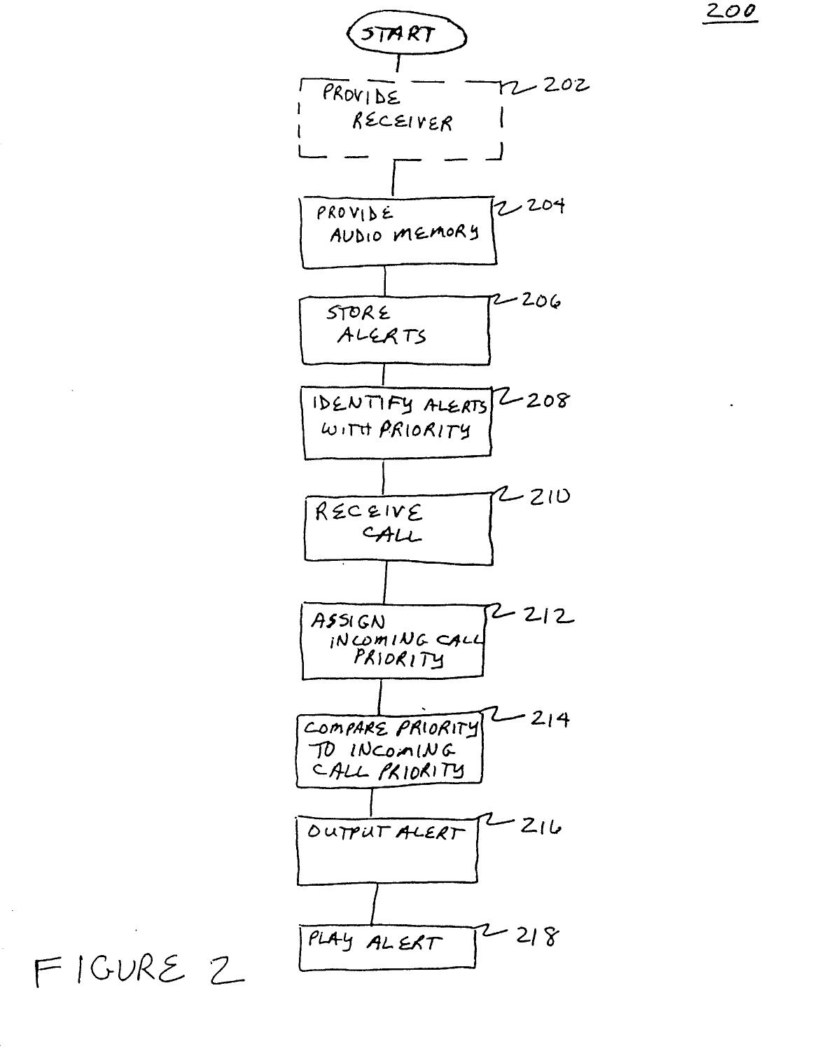

FIG. 2 is a flow diagram illustrating a method 200 of alerting a user to a mobile communication, or an incoming call, on a communication device. The method 200 may include the step 202 of providing a communication receiver in communicative contact with at least one communication station, and includes the step 204 of providing an audio memory, the step 206 of storing in the audio memory a plurality of audio alerts, the step 208 of identifying each audio alert with a category in the audio memory, the step 210 of receiving an incoming call at the communication receiver, the step 212 of assigning an incoming call category to the incoming call based on a comparison of the incoming call with a listing of known incoming call categories, the step 214 of comparing the incoming call category to the categories in the audio memory until a match is found, the step 216 of outputting from the step 214 of comparing the alert associated with the incoming call category according to the output of the match in the step 214 of comparing, and the step 218 of playing the alert associated with the incoming call category. The method 200 of the present invention operates substantially as discussed hereinabove with respect to FIG. 1.

Those of ordinary skill in the art will recognize that many modifications and variations of the present invention may be implemented. The foregoing description and the following claims are intended to cover all such modifications and variations.

What is claimed is:

1. A mobile communication device, comprising:
a communication receiver, wherein said communication receiver is in communicative contact with at least one communication station;
an audio memory that stores therein a plurality of audio alert types, wherein each alert type is identified with a category;
a call categorizer communicatively connected to said communication receiver that assigns an incoming call category to an incoming call received on the communication receiver;
a call comparator that compares the incoming call category to the category, wherein said call comparator outputs, according to said audio memory, the alert type associated with the incoming call category; and
an alert player that plays the alert type associated with the incoming call category.

2. The mobile communication device of claim 1, wherein said communication receiver comprises a mobile broadcast receiver.

3. The mobile communication device of claim 2, wherein said mobile broadcast receiver comprises one selected from the group consisting of a cellular telephone, a pager, and a personal digital assistant.

4. The mobile communication device of claim 1, wherein the incoming call comprises a short message service message.

5. The mobile communication device of claim 1, wherein the incoming call comprises at least one page.

6. The mobile communication device of claim 1, wherein the incoming call comprises caller ID information.

7. The mobile communication device of claim 1, wherein said audio memory comprises a RAM.

8. The mobile communication device of claim 1, wherein the alert type is at least one selected from the group consisting of a pulse, a short tone, a long tone, an MIDI sound, no sound, and a recorded sound.

9. The mobile communication device of claim 1, wherein the category is a criteria.

10. The mobile communication device of claim 9, wherein the criteria includes at least two categories.

11. The mobile communication device of claim 10, wherein each category is one selected from the group consisting of a broadcast of stock quotes, a broadcast of sports news, a broadcast of weather, and a broadcast of personal information.

12. The mobile communication device of claim 10, wherein the criteria is caller identification from whom the incoming message is received.

13. The mobile communication device of claim 12, wherein each category is one selected from the group consisting of a family member, a business associate, and a social acquaintance.

14. The mobile communication device of claim 10, wherein the criteria is urgency of the incoming message.

15. The mobile communication device of claim 14, wherein each category is one selected from the group consisting of an emergency message, an urgent message, an important message, a casual message, and an undesired message.

16. The mobile communication device of claim 10, wherein the incoming call category is according to the categories.

17. The mobile communication device of claim 1, wherein the incoming call category is resident in a call categorizer memory.

18. The mobile communication device of claim 1, wherein said audio alert player is selected from the group consisting of a buzzer, a speaker, and a horn.

19. The mobile communication device of claim 1, wherein said audio alert player operates in at least two modes.

20. A method of alerting a user to an incoming call on a communication receiver in communicative contact with at least one communication station, comprising:
providing an audio memory at the communication receiver;
storing in the audio memory a plurality of audio alerts;
identifying each audio alert with a category;
receiving an incoming call at the communication receiver;
assigning an incoming call category to the incoming call;
comparing the incoming call category to the category;
outputting from said comparing the alert associated with the incoming call category; and
playing the alert associated with the incoming call category.

21. The method of claim 20, wherein said receiving the incoming call comprises receiving a short message service message.

22. The method of claim 20, wherein said receiving the incoming call comprises receiving at least one page.

23. The method of claim 20, wherein said receiving the incoming call comprises receiving caller ID information.

24. A method of alerting a user to an incoming call on a communication device, comprising:
identifying an audio alert type with a category;
receiving an incoming call;
assigning an incoming call category to the incoming call;
comparing the incoming call category to the category; and
playing an alert associated with the incoming call category.

25. An alerter for alerting a user to an incoming call on a communication device, comprising:
means for identifying an audio alert type with a category;
means for receiving an incoming call on the communication device;
means for assigning an incoming call category to the incoming call;
means for comparing the incoming call category to the category; and
means for playing an alert associated with the incoming call category.
